(19) United States
(12) Patent Application Publication
(10) Pub. No.: US 2023/0243393 A1
(43) Pub. Date: Aug. 3, 2023

(54) PISTON FOR A BRAKE SYSTEM AND BRAKE SYSTEM

(71) Applicant: HL MANDO CORPORATION, Gyeonggi-do (KR)

(72) Inventor: Hatem SHAHIN, Pfaffenhofen (DE)

(21) Appl. No.: 18/102,701

(22) Filed: Jan. 28, 2023

(30) Foreign Application Priority Data
Jan. 28, 2022 (DE) 102022200960.6

(51) Int. Cl. F16D 65/18

(52) U.S. Cl. CPC F16D 65/18; F16D 2125/06

(57) ABSTRACT

The invention relates to a piston for a brake system, the piston having a first end configured to engage with a brake fluid and a second end configured to engage with a brake pad, and a piston wall surrounding a cavity of the piston between the first end and the second end. The piston wall comprises a plastic portion. A piston base is provided at the first end of the piston, which piston base closes the piston at the first end, the piston base comprising a metallic portion which is configured to contact the brake fluid. The invention also relates to a method for making a piston and to a brake system comprising a piston.

### CROSS-REFERENCE TO RELATED APPLICATION

This application is based on and claims priority under 35 U.S.C. § 119 to German Patent Application No. 102022200960.6, filed on Jan. 28, 2022 in the German Patent and Trade Mark Office, the disclosures of which are incorporated herein by reference.

### TECHNICAL FIELD

The present application is in the field of mechanical engineering, in particular vehicle technology. The application relates to a piston for a brake system. It also discloses a brake system comprising such a piston as well as a method for manufacturing the piston.

### BACKGROUND

According to the state of the art, disk brake systems typically comprise a housing holding a piston. The piston is pressed against a brake pad for braking. To this end, hydraulic pressure is exerted onto one side of the piston by way of a brake fluid present in a cavity of the housing.

The fluid volume of the brake fluid within this cavity and, in particular, the increase of fluid volume during braking, influence the pedal travel and pedal feel.

Moreover, as the piston engages with the brake pad, vibrations and noise can be transmitted to or generated within the piston.

### SUMMARY

It is thus an object of the present invention to improve pedal feel and/or to avoid noise and vibrations.

This is achieved by a piston according to claim 1. It is also achieved by a method for making a piston, or a brake system, as recited in claims 17 and 18. Advantageous embodiments can be found in the dependent claims and in the following description and the figures.

According to the invention, a piston for a brake system has a first end configured to engage with a brake fluid and a second end configured to engage with a brake pad, and a piston wall surrounding a cavity of the piston between the first end and the second end. The piston wall comprises a plastic portion. A piston base is provided at the first end of the piston, which piston base closes the piston at the first end, the piston base comprising a metallic portion which is configured to contact the brake fluid.

The metallic portion of the piston base plate may thus form an outer surface of the piston base, which constitutes a main pressing surface for the brake fluid.

A hydraulic brake system for a vehicle may comprise a housing, a brake pad and the piston according to any of the variants shown or described herein. The piston is movable along a longitudinal axis by hydraulic pressure acting on the piston base, for pressing the second end of the piston against the brake pad. To exert hydraulic pressure on the piston, brake fluid contained in a cavity of the housing may be pressurized.

During braking, as the brake system and in particular the piston heats up, the metallic portion of the piston base is subject to thermal expansion. As the metallic portion of the piston base expands, it reduces the volume available for the brake fluid in the cavity of the housing. In other words, expansion of the piston base may add to the pressure effected by the brake fluid. As a consequence, the amount of brake fluid that has to be displaced is reduced, which may inter alia result in improved pedal travel and pedal feel. The sizes and design features can advantageously be selected so that the expansion of the piston in axial direction is prioritized. This may in particular be achieved by the various embodiments shown herein.

In an embodiment, a thickness of the metallic portion of the piston base at room temperature may be at least 3 mm and/or at most 5 mm or at most 8 mm. In particular the thickness may be approximately 4 mm. The thickness is measured in the longitudinal direction in which the piston is configured to move. An increase in thickness Δx due to thermal expansion during braking may then be between 0.02 mm and 0.1 mm. Correspondingly, if a surface area of the metallic portion of the piston base, normal to the longitudinal direction, is denominated by A, an increase in volume is given by ΔV=Δx·A. Given typical piston dimensions, ΔV may for instance be between 0.1 and 0.3 cubic centimeters. The inventor has realized that the volume increase and increase in thickness associated with thermal expansion can thus be in the same order of magnitude as the brake fluid absorption and piston travel, respectively. Namely, in an example, approximately 0.7 to 1.2 cubic centimeters of brake fluid absorption within the cavity of the housing are envisioned during braking. For instance, this may lead to a displacement of the piston by as little as 0.01 to 0.03 mm, whereas the housing may be displaced by between 0.35 and 0.5 mm, or by between 0.38 and 0.4 mm. A sum of these two movements typically does not exceed 0.5 mm. The piston described herein is thus capable of impacting brake fluid absorption and pedal feel, based on thermal expansion of the metallic portion of the piston base.

Moreover, the metal portion of the piston base advantageously resists deformation by the brake fluid. I.e., inserting the metal portion facing the brake fluid pressure may improve the strength of the piston and reduce the axial deflection of the piston base.

The piston comprises the metal portion of the piston base, on the one hand, and the plastic portion of the piston wall, on the other hand, and thus it comprises at least two portions made of different materials. This may advantageously dampen vibrations or noise, for instance due to a joint damping effect.

The hybrid setup, wherein the piston comprises at least the two above-mentioned portions of different materials also helps to achieve a target mass for the piston, or even decrease the mass of the piston compared to known pistons.

In particular, the piston may be a piston for a front axle of a vehicle, such as a car or a truck. Therein, the piston may be open at the second end, while it is closed at the first end as described above.

The metallic portion of the piston base may for instance be disk-shaped.

The piston base may comprise a plastic portion which is arranged at an inner side of the metallic portion of the base plate, facing the cavity.

For example, a total thickness of the piston base, in particular including the metallic portion of the piston base and the plastic portion of the piston base, may be at least 4 mm and/or at most 8 mm.

In possible embodiments of the piston, the piston wall may comprise a metallic portion. This metallic portion of the piston wall may advantageously reduce compressibility of the piston in the axial direction. It may also enable heat transfer to the metallic portion of the piston base.

In either case, with or without the metallic portion, the piston wall may comprise a bent portion at the second end, for increasing a contact area with the brake pad.

The plastic portion of the piston wall may extend to the second end of the piston and may be configured to engage with the brake pad, in particular with a back plate of the brake pad. It may be envisioned that the metallic portion of the piston wall is configured not to contact the brake pad. Instead, only the plastic portion of the piston wall engages with the brake pad. This may be envisioned for reducing noise and vibration.

Alternatively, the metallic portion of the piston wall may extend to the second end of the piston and be configured to engage with the brake pad, in particular with the back plate of the brake pad. Then, the metallic portion of the piston wall may act as a heat conductor for transferring heat from the brake pad into the piston.

Additionally or alternatively, the metallic portion of the piston wall may contact the metallic portion of the piston base. If the metallic portion of the piston wall both contacts the metallic portion of the piston base and is configured to engage with the brake pad, it may conduct heat from the brake pad to the metallic portion of the piston base.

The metallic portion of the piston wall may for instance be formed integrally with the metallic portion of the piston base. Alternatively, it is possible to have the metallic portion of the piston wall and the metallic portion of the piston base as separate parts. A geometric connection feature may be provided between the metallic portion of the piston wall and the metallic portion of the piston base, for connecting them to each other. In particular this may be a protrusion-recess-connection. This may add to a joint damping effect.

In possible embodiments, the piston wall may comprise one or more plastic portions and one or more metallic portions. They may form shells that are arranged in layers. In particular, the plastic portions and the metallic portions may be arranged in an alternating fashion. This provides additional joinings which may add to a joint damping effect. For instance, an inner shell, facing the cavity of the piston, may be a plastic layer, followed by a metallic layer. This may be followed again by a further plastic layer. Alternatively, an inner shell, facing the cavity of the piston, may be a metallic layer, followed by a plastic layer. This may be followed again by a further metallic layer. It is also possible to have more than 3 layers, such as, for instance 4 layers.

Each of these layers may for instance have a thickness of at least 1 mm and/or of at most 4 mm.

A geometric feature may be provided between the metallic portion of the piston wall and the plastic portion of the piston wall. In particular, a step or a protrusion-recess-connection may be provided between them. For instance, if the metallic portion of the piston wall and the plastic portion of the piston wall are arranged in layers, a step-feature may be envisioned, which is designed such that the thickness of the metallic layer decreases from the second end towards the first end, and the thickness of the plastic layer increases from the second end towards the first end.

It may be envisioned that the metallic portion of the piston wall is made of a different metal than the metallic portion of the piston base. Alternatively or additionally, they may have a different thermal expansion coefficient from each other.

The metallic portion of the piston base and/or the metallic portion of the piston wall may comprise a sheet metal and/or a cast metal.

The metallic portion of the piston base and/or the metallic portion of the piston wall may comprise copper and/or aluminum and/or steel.

The metallic portion of the piston base may have a coefficient of thermal expansion α of at least 35E-6 1/K and/or at most 70E-6 1/K at room temperature. In particular, it may comprise steel and exhibit a coefficient of thermal expansion α=35E-6 1/K. It may comprise copper and exhibit α=50E-6 1/K. It may comprise Aluminum and exhibit α=70E-6 1/K.

The plastic portion of the piston base and/or the plastic portion of the piston wall may be made of a thermoplastic.

A method for making the piston shown and described herein, may comprise a casting process and/or an injection molding process and/or additive manufacturing. In particular, the method may comprise both a casting process for forming one or more of the metallic portions and an injection molding process for forming one or more of the plastic portions.

It should be understood that the aspects explained herein with the method of making the piston may be claimed for the piston itself, and vice versa.

### BRIEF DESCRIPTION OF DRAWINGS

The invention will now be explained with reference to the appended figures.

Therein,

FIG. 1 shows a brake system in a non-braking state;

FIG. 2 shows a brake system in a braking state;

FIGS. 3-5 show a piston for a brake system, comprising a piston base having a metallic portion and a plastic portion, and a piston wall having a metallic portion and a plastic portion;

FIGS. 6-8 show a piston for a brake system, comprising a piston base having a metallic portion, and a piston wall having a metallic portion and a plastic portion;

FIGS. 9-10 show a piston for a brake system, comprising a piston base having a metallic portion, and a piston wall having a metallic portion and a plastic portion;

FIGS. 11-12 show a piston for a brake system, comprising a piston base having a metallic portion, and a piston wall having a plastic portion;

FIGS. 13-14 show a piston for a brake system, comprising a piston base having a metallic portion and a plastic portion, and a piston wall having a plastic portion;

FIGS. 15-16 show a piston for a brake system, comprising a piston base having a metallic portion, and a piston wall having a plastic portion and two metallic layers;

FIGS. 17-18 show pistons for a brake system, comprising a piston base having a metallic portion, and a piston wall having a metallic portion and a plastic portion;

FIGS. 19-20 show a piston for a brake system, comprising a piston base having a metallic portion, and a piston wall having a metallic portion and a plastic portion interrupting the metallic portion;

FIGS. 21-22 show a piston for a brake system, comprising a piston base having a metallic portion and a plastic portion, and a piston wall having a metallic portion and a plastic portion, wherein thermal expansion of the metallic portion of the piston base is illustrated;

FIGS. 23-24 show a piston for a brake system, comprising a piston base having a metallic portion, and a piston wall having a plastic portion, wherein thermal expansion of the metallic portion of the piston base is illustrated;

FIGS. 25-26 show pistons for a brake system, comprising a piston base having a metallic portion, and a piston wall having a metallic portion and a plastic portion, the metallic portion of the piston wall and the metallic portion of the piston base being separate pieces;

FIGS. 27-28 show pistons for a brake system, comprising a piston base having a metallic portion, and a piston wall having a metallic portion and a plastic portion, with geometric connection features between the metallic portion of the piston wall and the metallic portion of the piston base;

FIGS. 29-30 show pistons for a brake system, comprising a piston base having a metallic portion, and a piston wall having a metallic portion and a plastic portion, with step-structures between the metallic portion of the piston wall and the plastic portion of the piston wall;

FIGS. 31-32 show pistons for a brake system, comprising a piston base having a metallic portion, and a piston wall having a metallic portion and a plastic portion, with protrusion-recess-structures between the metallic portion of the piston wall and the plastic portion of the piston wall; and

FIGS. 33-34 show pistons for a brake system, comprising a piston base having a metallic portion, and a piston wall having a metallic portion and a plastic portion, wherein the plastic portion of the piston wall extends beyond the metallic portion of the piston wall.

### DETAILED DESCRIPTION

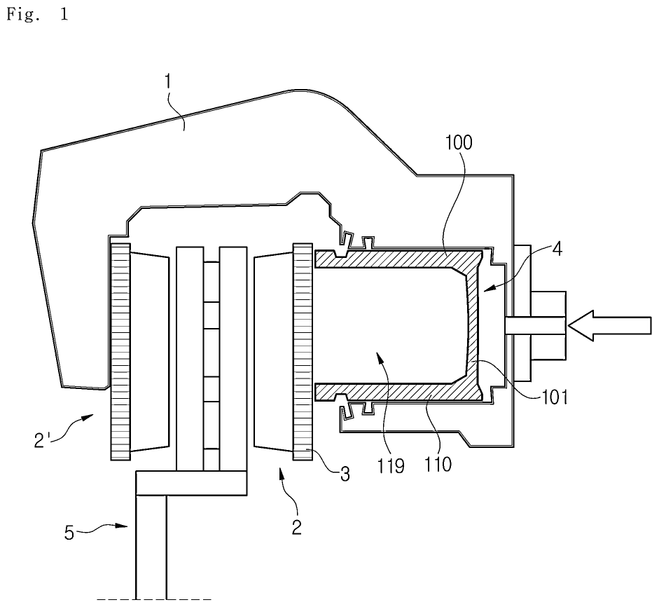

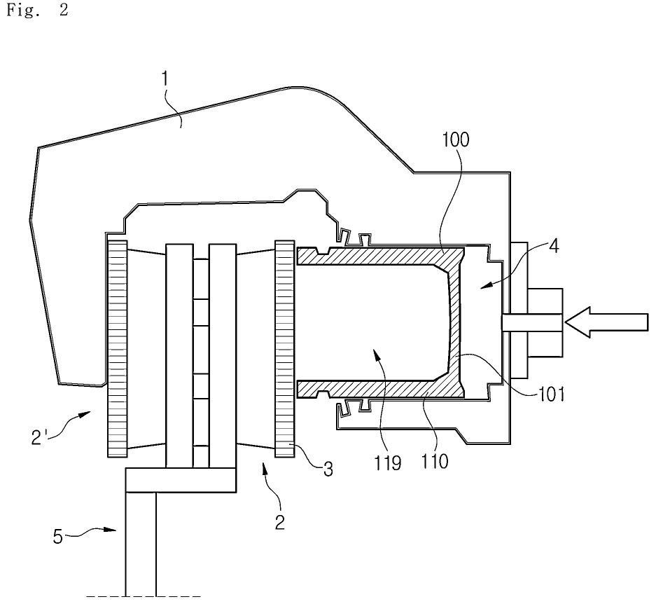

FIGS. 1, 2 show a hydraulic brake system for a vehicle, comprising a housing 1, a brake disk 5, a brake pad 2 arranged at an inner side of the brake disk 5, a further brake pad 2′ arranged at an outer side of the brake disk 5, and a piston 100 that is movable along a longitudinal axis by hydraulic pressure, for pressing against the brake pad 2.

The piston 100 is at the focus of the present application and various designs are shown in the following figures. The piston 100 has a first end configured to engage with the brake fluid. A piston base 101 closes the piston 100 at the first end. The piston 100 has a second end which is designed as an open end and configured to engage with the brake pad 2. A piston wall 110 surrounds a cavity 119 of the piston 100 between the first end and the second end.

FIG. 1 shows the system in a non-braking state and FIG. 2 shows the system in a braking state.

For braking, brake fluid is injected into a cavity 4 of the housing 1 to exert pressure on the piston base 101, as indicated by an arrow. As pressure builds within the cavity 4 of the housing 1, the cavity volume increases and the piston 100 is displaced towards the brake pad 2 by typically between 0.01 to 0.03 mm, and the housing 1 is displaced towards the further brake pad 2′ by typically between 0.38 and 0.4 mm. Thereby, the volume of the cavity 4 increases for instance by approximately 0.7 cubic centimeters. It is an object of the present invention to limit this increase in volume, which corresponds to an amount of brake fluid displaced.

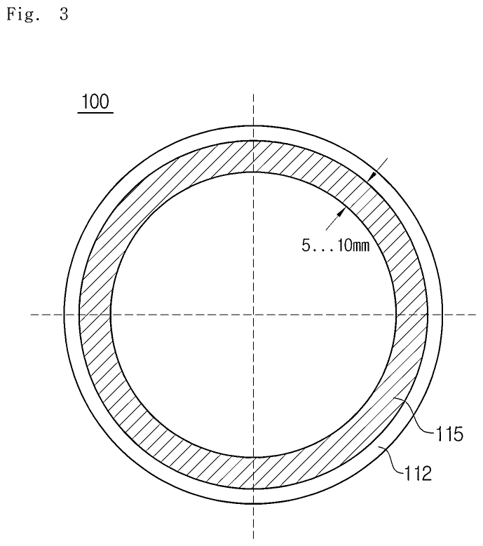

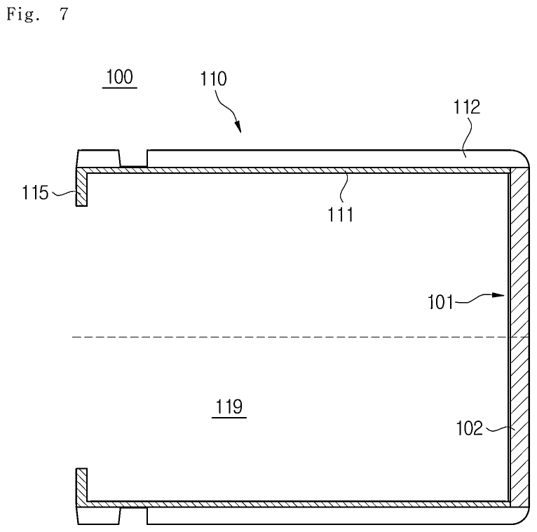

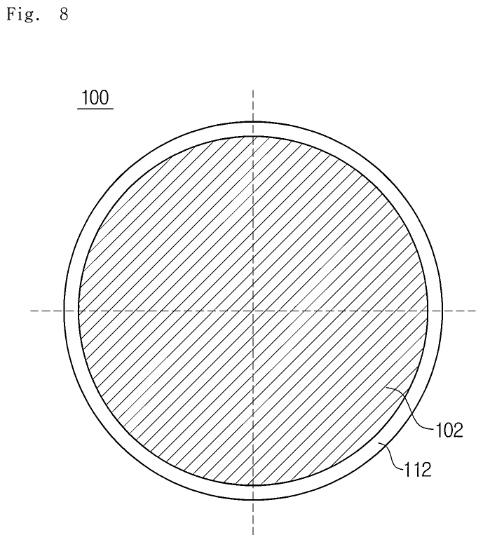

FIGS. 3-34 show different embodiments of the piston 100 that may be used in the brake system shown in FIGS. 1, b. In each case, the piston 100 has the first end, configured to engage with a brake fluid, and the second end, configured to engage with the brake pad 2. Furthermore, in each case the piston wall 110 surrounds the cavity 119 of the piston 100 between the first end and the second end. Furthermore, the piston wall 110, in each case, comprises a plastic portion 112, and the piston base 101, which closes the piston 100 at the first end, comprises a metallic portion 102 which is configured to contact the brake fluid.

In the case of each of FIGS. 3-34, with regard to the piston 100, the metallic sections are shown hatched and the plastic sections are shown without filling.

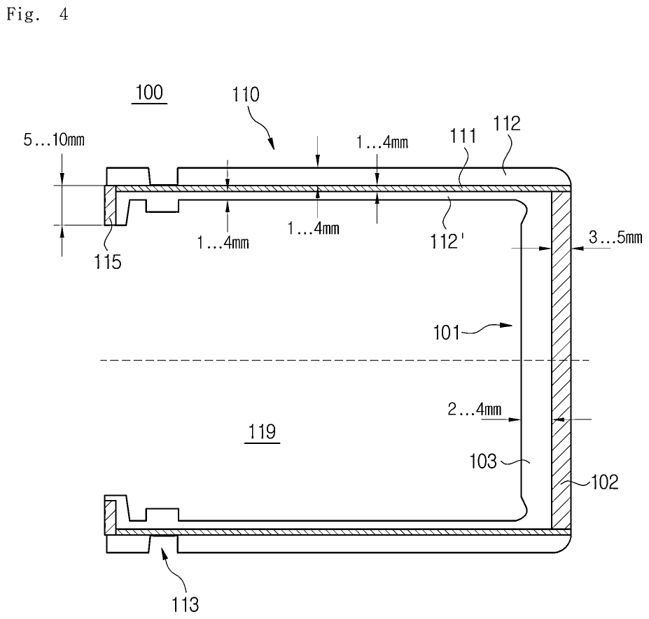

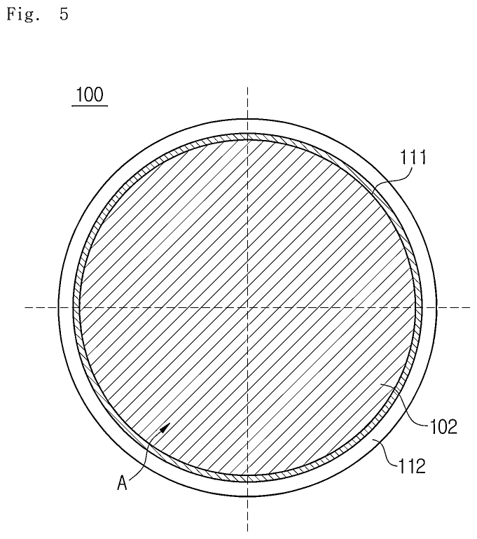

FIGS. 3-5 show different views of an embodiment of the piston 100, wherein the piston is made of a metal and a plastic material, such as a thermosplast. FIG. 3 shows a view onto the second end of the piston that is configured to be pressed against the brake pad 2. FIG. 4 shows a sectional view along a longitudinal axis of the piston, and FIG. 5 shows a view onto the first end of the piston which engages with the brake fluid.

The piston wall 110 comprises a first plastic portion 112 facing the cavity, and a second plastic portion 112 forming an outer hull of the piston wall 110, and a metallic portion 111 that is designed as a metal sheet interposed between the two plastic portions 112, 112′. The three portions 111, 112, 112′ are thus arranged as layered shells. A thickness of each of the layers or portions of the piston wall 110 is between 1 and 4 mm. In particular, a thickness of the metallic portion 111 may be chosen to be 3 mm.

The metallic portion 111 of the piston wall 110 extends to the second end of the piston 100 and is configured to engage with the brake pad 2. There is a bent section 115 formed by the metallic portion 111 of the piston wall 110, which increases the area that engages with the brake pad. A width of the bent portion is between 5 and 10 mm, in particularly it may be chosen to be 8 mm.

At the first end, the metallic portion 111 of the piston wall 110 contacts the metallic portion 102 of the piston base 101. The metallic portion 102 of the piston base 101 is in the shape of a disk, as can best be seen in FIG. 5. This disk has a thickness of 3 to 5 mm. An area of the disk is denominated by the letter A.

On the inside of the metallic portion 102 of the piston base 101, i.e., facing the cavity 119 of the piston 100, a plastic portion 103 is provided, which pertains to the piston base 101. This plastic portion 103 of the piston base 101 is formed integrally with the second plastic portion 112 of the piston wall 110. It has a thickness of between 2 and 4 mm, wherein it may be envisioned that a total thickness of the piston base 101 does not exceed 8 mm.

A seal groove 113 is provided on the outside of the piston wall 110.

The metallic portion 102 of the piston base 102 is a sheet metal or a cast metal.

The metallic portion 102 of the piston base 102 and the metallic portion 111, 111′ of the piston wall 110 comprise at least one of copper, aluminum and steel.

The plastic portion 103 of the piston base 101 and the plastic portion 112, 112′ of the piston wall are made of a thermoplastic.

The piston is made by at least one of a casting process and an injection molding process and additive manufacturing.

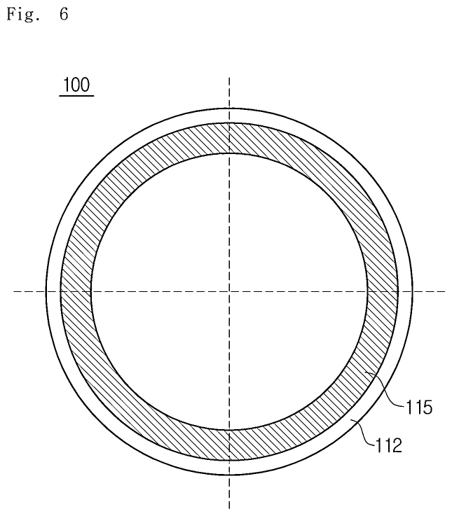

FIGS. 6-8 show a piston 100, wherein the metallic portion 102 of the piston base 101 and the metallic portion 111 of the piston wall 110, including a bent portion 115, are formed integrally with each other. These portions may be manufactured by casting. They form an inner part of the piston 100, and a plastic portion 112 of the piston wall 110 forms a hull disposed on the outside of the metallic portion 111 of the piston wall 110. The plastic portion 112 is made of a thermoplastic and may be injection-molded onto the metal portion 111. Heat conduction from the bent portions 115 to the metallic portion 112 of the piston base 101 is facilitated by this setup.

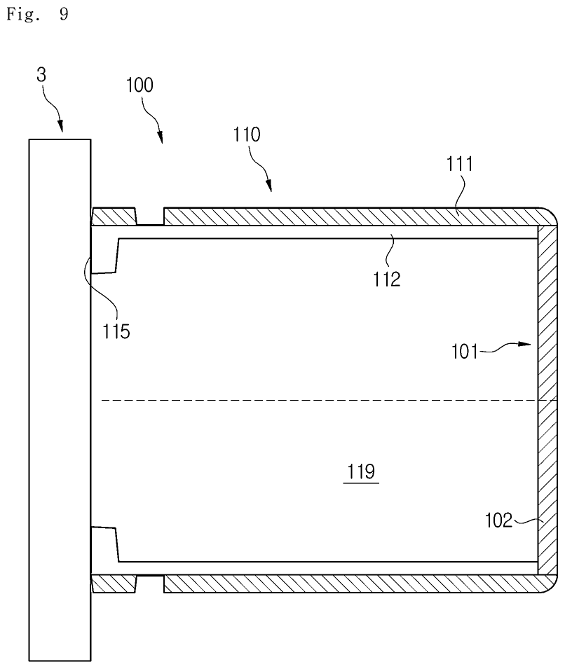

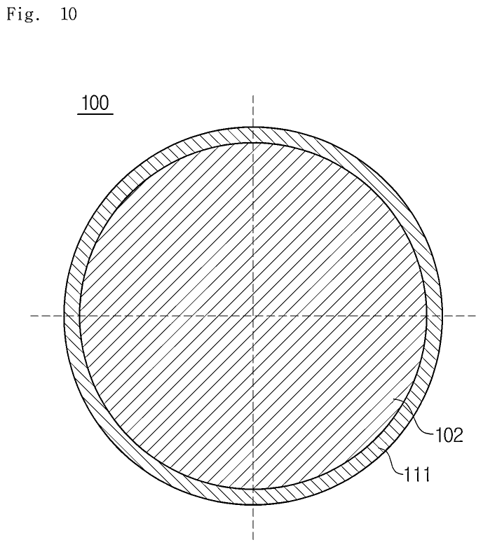

FIGS. 9, 10 show a piston 100, wherein the metallic portion 111 of the piston wall 110 is formed as a separate piece from the metallic portion 102 of the piston base 101. The metallic portion 111 of the piston wall 110 contacts the metallic portion 102 of the piston base 101 at the first end, and a plastic portion 112 of the piston wall 110 is arranged on the inside of the metallic portion 111, facing the cavity 119 of the piston. The plastic portion 112 of the piston wall 110 includes a bent portion 115 for contacting a back plate 3 of a brake pad 2. By having separate pieces, a joint damping effect may be achieved which reduces noise and vibrations.

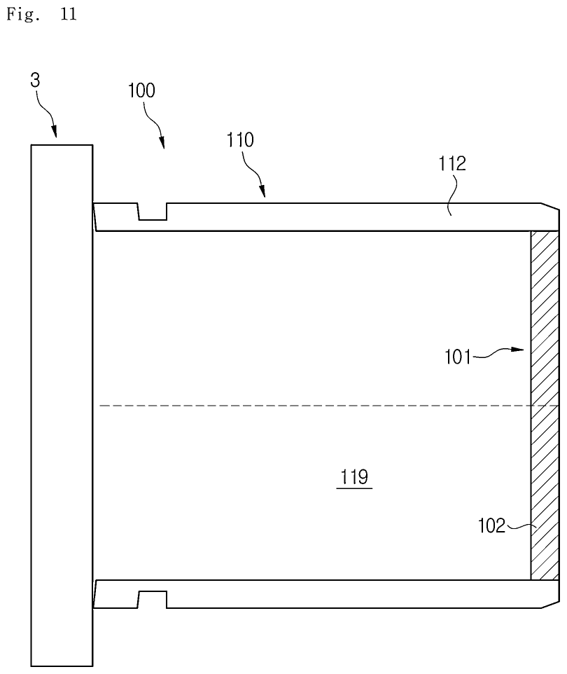

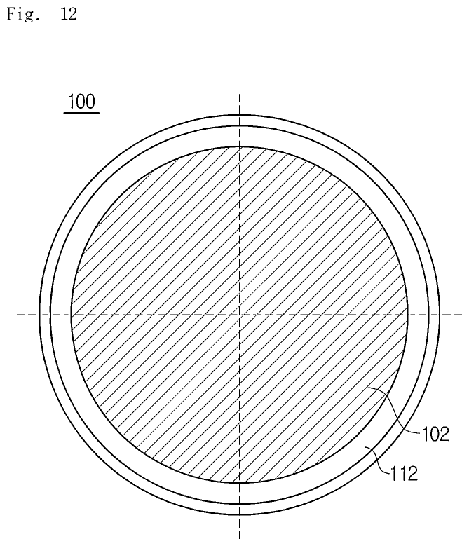

FIGS. 11, 12 show a piston 100 which comprises a metallic portion 102 forming a disk-shaped base 101 of the piston 100 and a cylindrical plastic portion 112 forming a wall 110 of the piston.

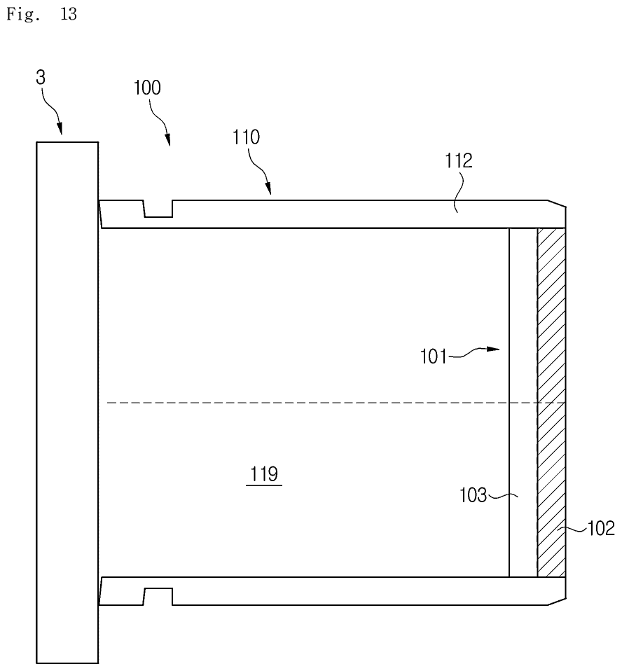

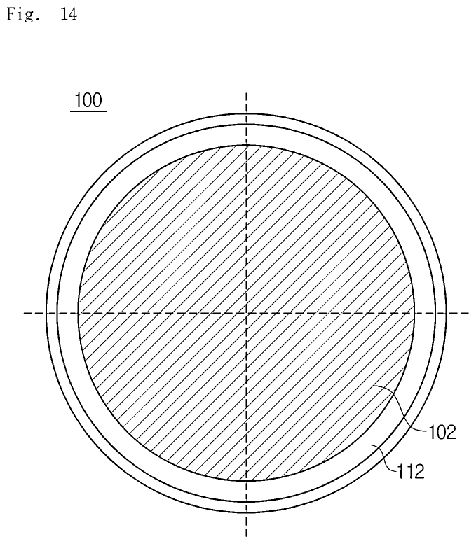

FIGS. 13, 14 show a piston 100 wherein a piston wall 110 consists of a cylindrical plastic portion 112 and a piston base 101 is formed by a disk-shaped metallic portion 102. The setup differs from the setup of FIGS. 11, b in that there is a plastic portion 103 arranged at the inner side of the metallic portion 102 of the piston base 101. This may result in a sturdy design where the metal disk forming the metallic portion 102 is received and partly enclosed by the plastic portions 103, 112.

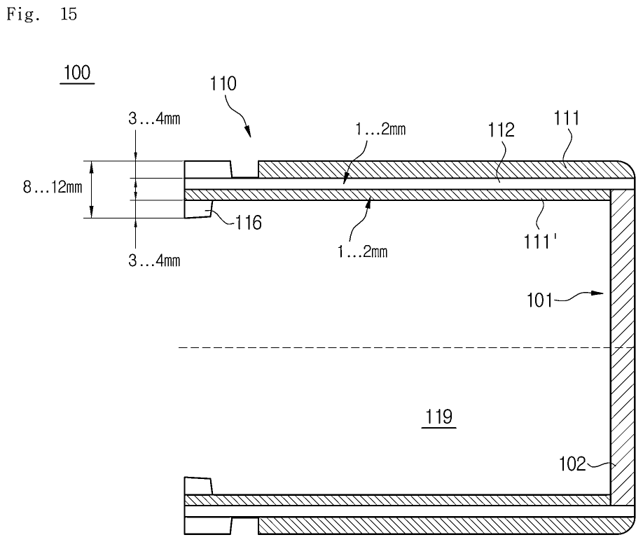

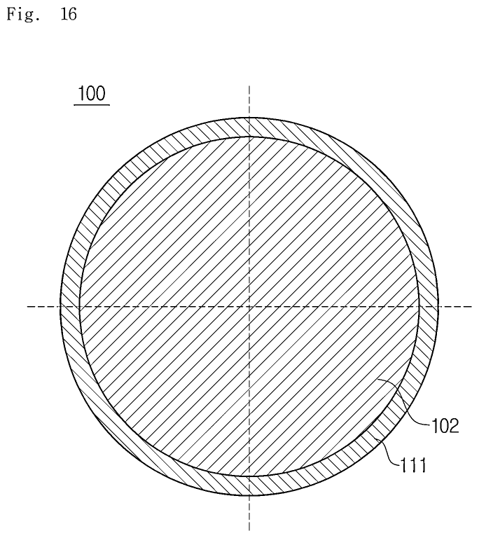

FIGS. 15, 16 show a piston 100 having, once again, a metal disk forming the metallic portion 102 of the piston base 101. The piston wall 110 comprises two metallic portions 111, 111′ and a plastic portion 112 disposed between the metallic portions 111, 111′.

The portions of the piston wall 110 form shells that are arranged in layers. A first metallic portion 111 of the piston wall 110 forms an outer layer and has a thickness of 3 to 4 mm. It is followed by the plastic portion 112, which forms a central layer and has a thickness of 1 to 2 mm. Finally, there is the second metallic portion 111′, which forms the innermost layer, facing the cavity 119 of the piston 100. The second metallic portion 111′ has a thickness of 1 to 2 mm.

There is a step between an first metallic portion 111 and the remaining two portions 112, 111′ of the piston wall 110, for receiving the metallic portion 102 of the piston base 101.

There is a protruding feature 116, protruding from the piston wall 110 at the second end of the piston 100 towards a central axis of the cylindrical piston, for increasing a contact area for contacting the brake pad 2. It is made of plastic. It is between 3 and 4 mm wide. A total width of a ring-shaped contact area for contacting the brake pad 2 is for instance between 8 and 12 mm.

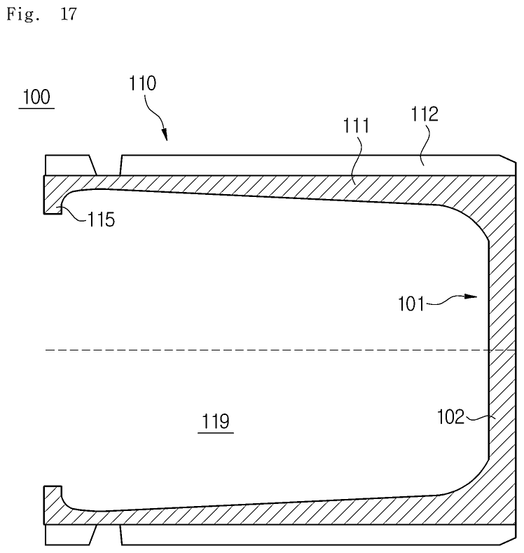

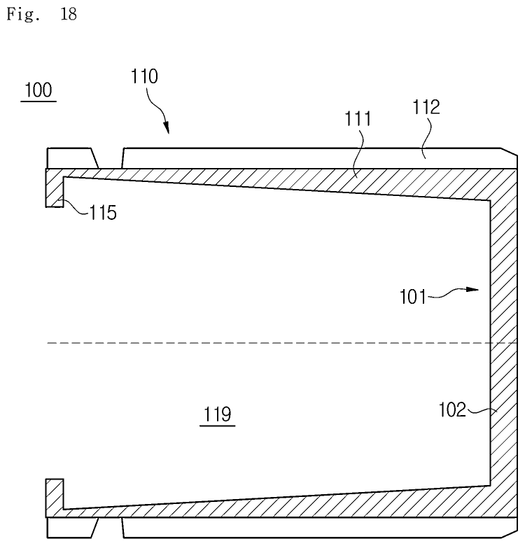

FIGS. 17, 18 show pistons having, in each case, a metallic portion 102 of the piston base 101 that is formed integrally with a metallic portion 111 of the piston wall 110, for instance by casting. At the second end, optional bent portions 115 are provided at the metallic portion 111. A plastic portion 112 of the piston wall is in each case provided on the outside of the metallic portion 111 of the piston wall. This design provides a stiff connection between the piston base 101 and the piston wall 110.

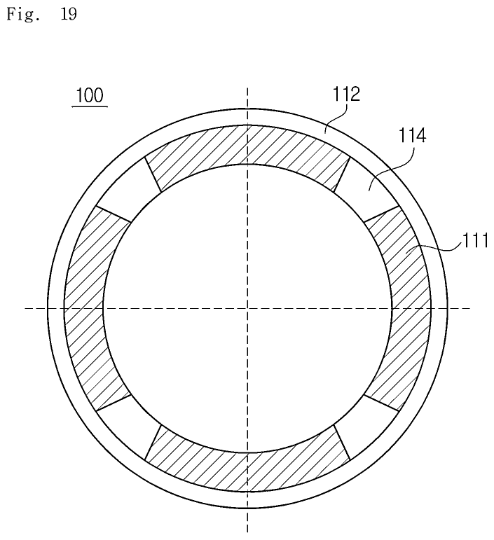

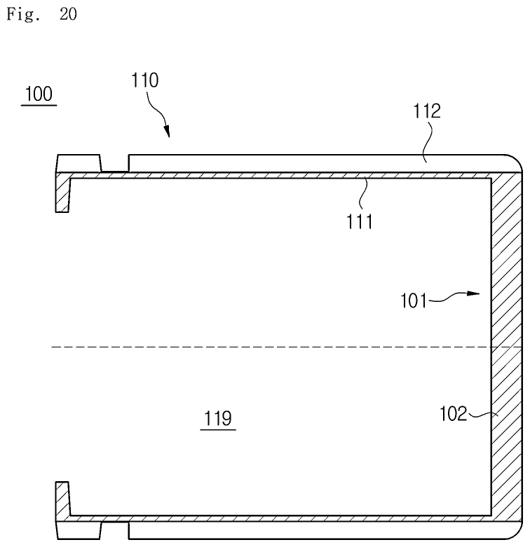

FIGS. 19, 20 show a piston 100 that has a metallic portion 111 of the piston wall 110 which is formed integrally with the metallic portion 102 of the piston base 101. A plastic portion 112 of the piston wall 112 is provided on the outside of the metallic portion 111. The metallic portion 111 of the piston wall 110 is cut in the longitudinal direction and accordingly forms recesses extending in the longitudinal direction. In these recesses, plastic material protruding from the plastic portion 112 is provided. This plastic material extends longitudinally, as can best be seen from FIG. 19, and forms a protrusion-recess connection between the two layers of the piston wall 110.

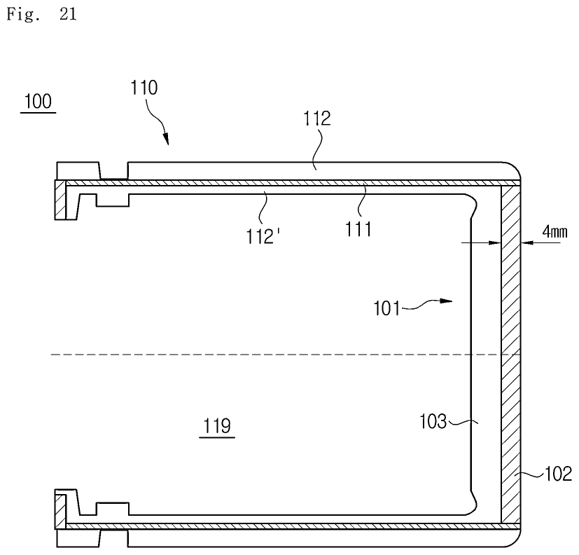

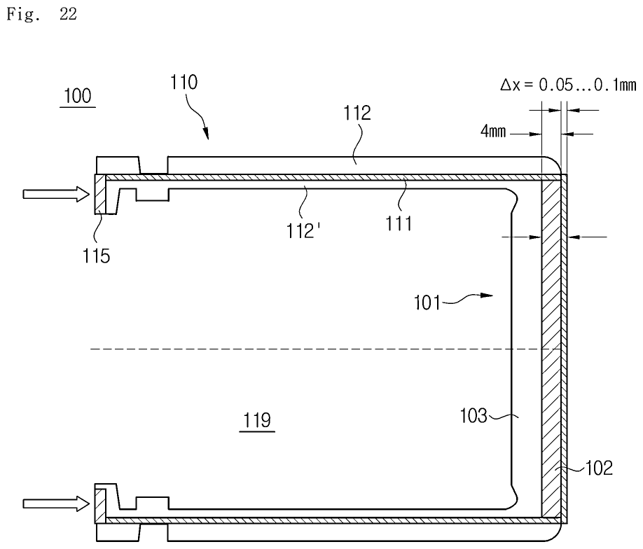

FIGS. 21-22 illustrate thermal expansion of the metallic portion 102 of the piston base 101, wherein a thermal connection to the brake pad 2 is created by way of the metallic portion 111 of the piston wall 110. By way of example, the piston design of FIG. 2 is used for illustrating this concept. However, the same applies to other designs that feature a metallic portion 111 of the piston wall 110.

In the initial non-braking state (FIG. 21), at room temperature, the metallic portion 102 of the piston base 101 has a thickness of 4 mm.

During braking (FIG. 22), the bent section 115 of the metallic portion 111 of the piston wall 110 enters in contact with the brake pad 2, in particular for instance a back plate 3 of the brake pad. Due to friction between the brake pad 2 and the brake disk 5, the system heats up and temperatures up to for instance 350° C. may be achieved. Heat transfer takes place, as indicated by arrows, inter alia through metallic contact, from the brake pad 2 through the bent section 115 and the metallic portion 111 of the piston wall 110, all the way to the metallic portion 102 of the piston base 101. The thickness of the metallic portion 102 increases due to thermal expansion, by a value Δx, which may for instance be between 0.05 and 0.1 mm. Due to this axial thermal increase Δx, the disk increases in volume by ΔV=Δx·A, where A denominates a surface area of the metallic portion 102 of the piston base. This volume increase of the piston is in an outward direction, and leads to a decrease in cavity volume available in the cavity 4 of the housing 1, limiting the amount of brake fluid that can be received therein, and adding to the pressure caused by the brake fluid.

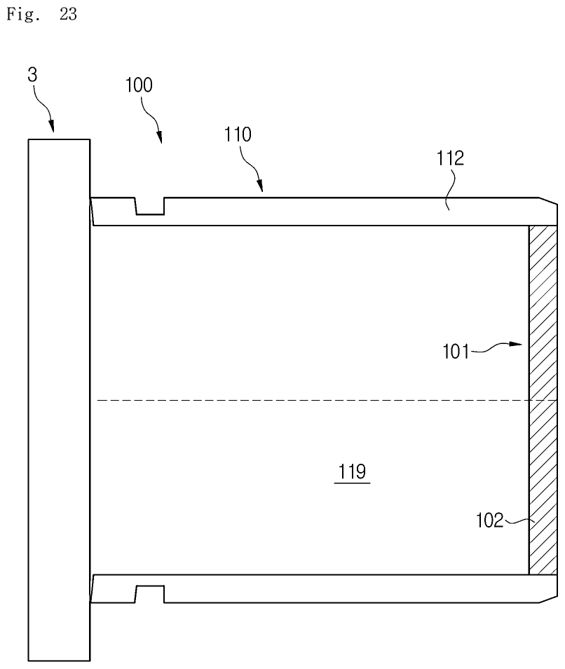

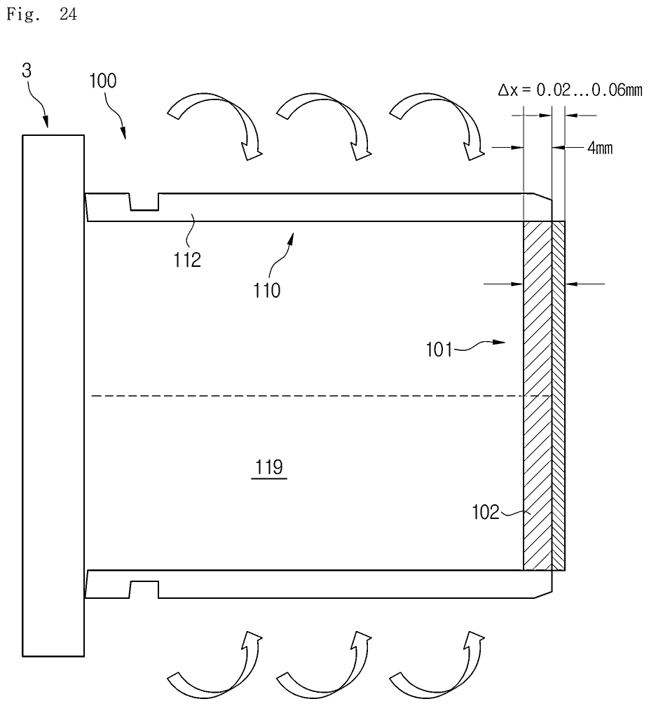

FIGS. 23, 24 illustrate thermal expansion of the metallic portion 102 of the piston base 101, similarly to FIGS. 21, b. However, in the case of FIGS. 23, b there is no metallic connection between the backplate 3 of the brake pad 2 and the metallic portion 102 of the piston base 101. Therefore, during braking (FIG. 24), heat transfer takes place through an environment of the piston, as indicated by the arrows. For instance, axial thermal increase Δx of between 0.02 and 0.06 mm may be achieved.

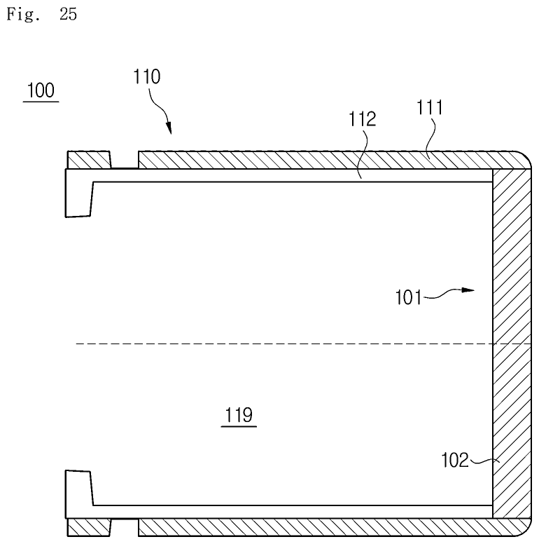

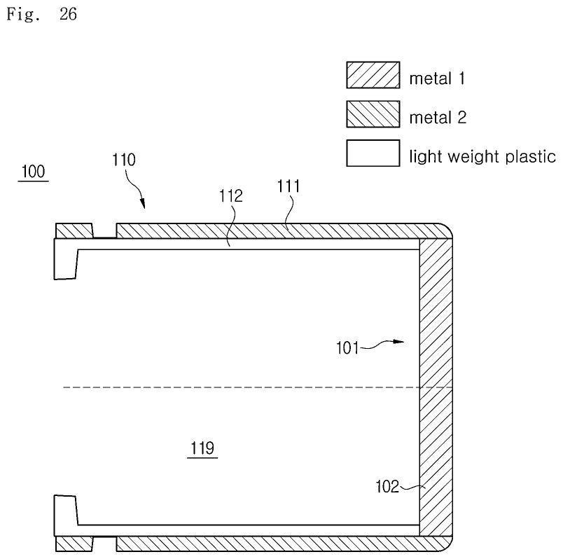

FIGS. 25, 26 show pistons having a metallic portion 102 of the piston base 101, a plastic portion 112 of the piston wall 110. Additionally, a metallic portion 111 of the piston wall 110 is provided

In the case shown in FIG. 25, the metallic portion 111 of the piston wall 110 is made of the same metal as the metallic portion 102 of the piston base 101.

In the case shown in FIG. 26, the metallic portion 111 of the piston wall 110 is made of a different metal than the metallic portion 102 of the piston base 101. In particular, it is made of a metal having a different thermal expansion coefficient. Therein, the two metals of the two metallic portions 111, 102 may have different constituents, or they may have the same constituents in a different ratio or different configuration.

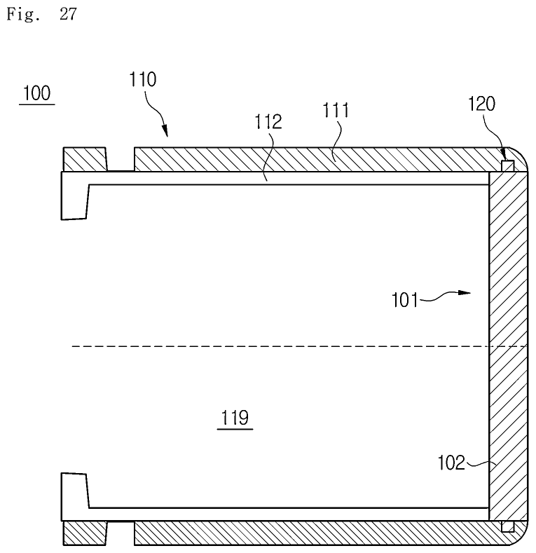

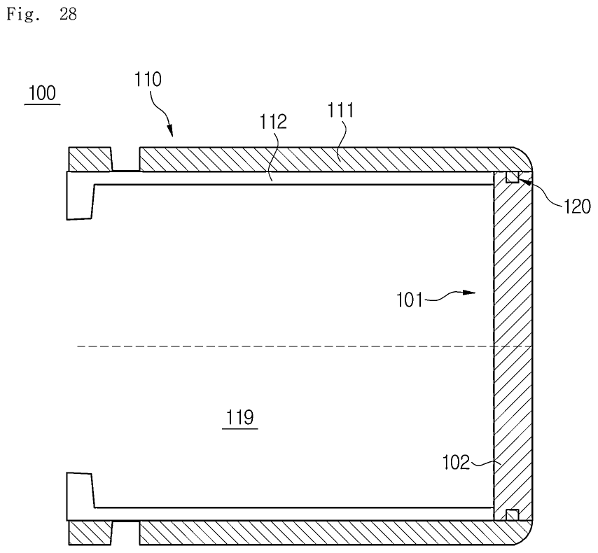

FIGS. 27, 28 show pistons having a metallic portion 102 of the piston base 101, a plastic portion 112 of the piston wall 110. Additionally, a metallic portion 111 of the piston wall 110 is provided. A geometric connection feature 120 is provided between the metallic portion 111 of the piston wall 100 and the metallic portion 102 of the piston base 101. The geometric feature is designed as a protrusion-recess-connection. The setup may advantageously dampen noise or vibrations. FIG. 27 shows that the metallic portion 111 of the piston wall 110 is made of the same metal as the metallic portion 102 of the piston base 101. FIG. 28 shows that the metallic portion 111 of the piston wall 110 is made of a different metal than the metallic portion 102 of the piston base 101.

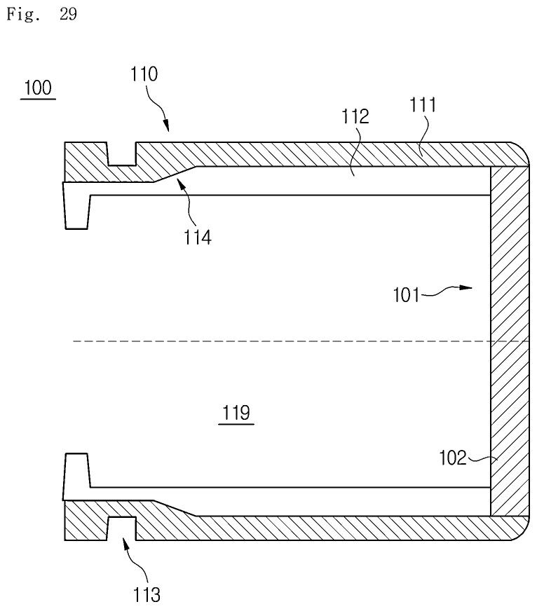

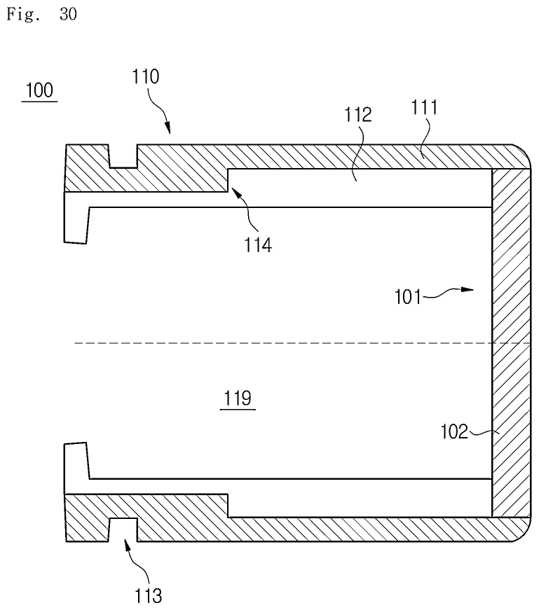

FIGS. 29, 30 show piston designs wherein the piston wall 110 has a metallic portion 111 and a plastic portion 112, and a geometric feature 114 is provided between the metallic portion 111 of the piston wall 110 and the plastic portion 112 of the piston wall 110. Therein, the thickness of the metallic portion 111 increases from the first end to the second end, and the thickness of the plastic portion 112 decreases from the first end to the second end. This improves the creep behavior of the piston 100, which is only supported by the seal provided in the seal groove 113. The concentration of the metal near the seal can minimize creep and achieve better positioning of the piston.

FIG. 29 shows that the geometric feature 14 is designed as an inclined step. FIG. 30 shows that the geometric feature 14 is designed as a hard step.

Exemplarily, FIG. 29 shows that the two metal portions are made of the same metal and FIG. 30 shows that they are made of different metals. The opposite configuration is also envisioned.

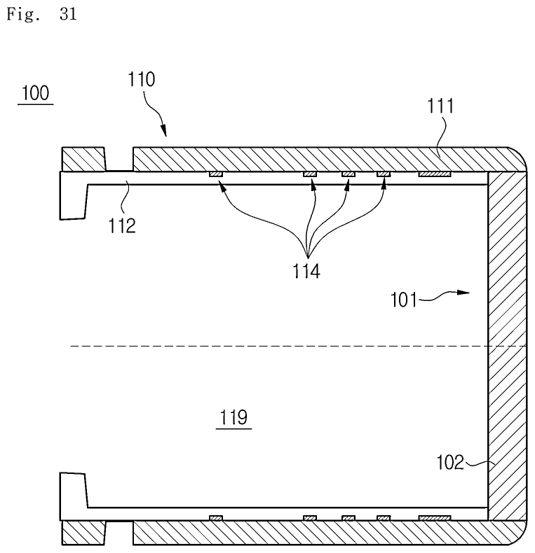

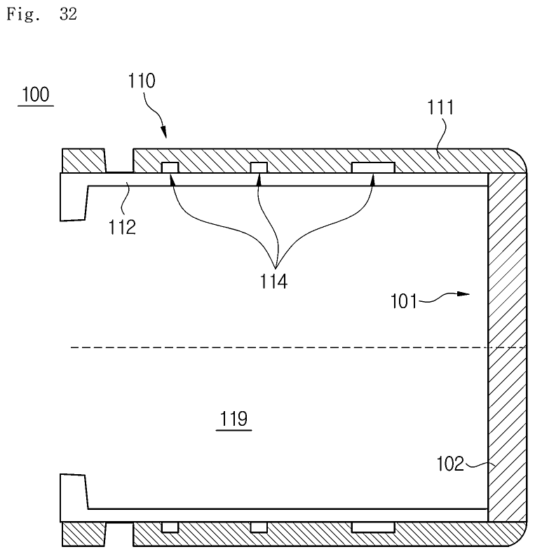

FIGS. 31, 32 show further examples where geometric features 114 are provided between the metallic portion 111 of the piston wall 110 and the plastic portion 112 of the piston wall 110. The geometric features are protrusion-recess-connections. The protrusions extend tangentially around the piston 100. These feature increase joint damping.

In the setup shown in FIG. 31, there are metal protrusions which protrude from the metal portion 111 and extend into recesses formed in the plastic portion 112.

In the setup shown in FIG. 32, there are plastic protrusions protruding from the plastic portion 112 and extending into recesses formed in the metallic portion 112.

Exemplarily, FIG. 31 shows that the two metal portions are made of the same metal and FIG. 32 shows that they are made of different metals. The opposite configuration is also envisioned.

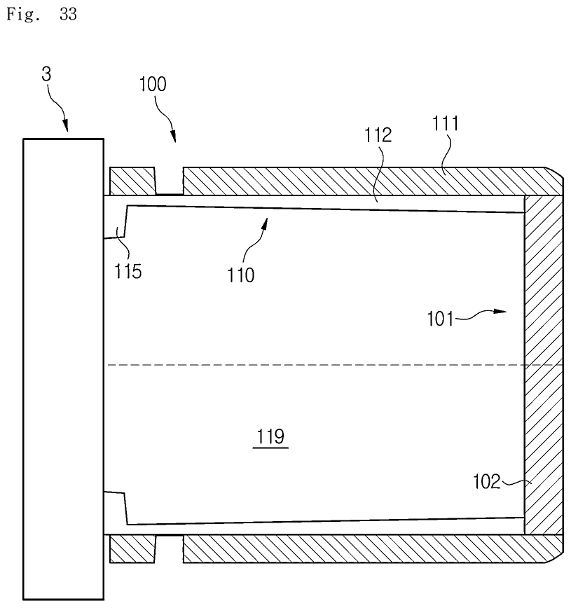

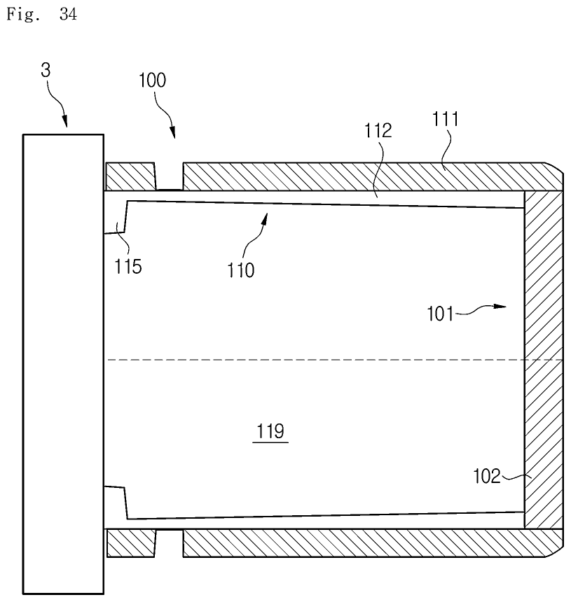

FIGS. 33, 34 show pistons having a piston wall 110 with a metallic portion 111 and a plastic portion 112. The plastic portion 112 of the piston wall 110 extends to the second end of the piston 100 and is configured to engage with the brake pad 2, in particular with the backplate 3 of the brake pad.

The metallic portion 111 of the piston wall 110 is thereby configured not to contact the brake pad 2. To maintain a gap between the metallic portion 111 of the piston wall 110 and the brake pad 2, the plastic portion 112 extends by between 0.5 mm and 1 mm beyond the metallic portion at the second end. A metal-metal contact between the piston and the brake pad 2 can thus be avoided, and noise or damage of the brake pad 2 is reduced.

### LIST OF REFERENCE NUMERALS

1 Housing
2, 2′ Brake Pad
3 Backplate of the Brake Pad
4 Cavity for Brake Fluid
5 Brake disk
100 Piston
101 Piston Base
102 Metallic Portion of the Piston Base (Base Disk)
103 Plastic Portion of the Piston Base
110 Piston Wall
111, 111′ Metallic Portion of the Piston Wall
112, 112′ Plastic Portion of the Piston Wall
113 Seal Groove
114 Geometric Feature between Wall Portions (Step/Protrusion/Recess)
115 Bent section
116 Protruding feature
119 Cavity
120 Geometric Connection Feature between Piston Base and Piston Wall

1. A piston for a brake system, the piston having a first end configured to engage with a brake fluid and a second end configured to engage with a brake pad, and a piston wall surrounding a cavity of the piston between the first end and the second end,
wherein
the piston wall comprises a plastic portion,
and wherein
a piston base is provided at the first end of the piston, which piston base closes the piston at the first end, the piston base comprising a metallic portion which is configured to contact the brake fluid.

2. The piston according to claim 1, wherein the metallic portion of the piston base is disk-shaped.

3. The piston according to claim 1, wherein the piston base comprises a plastic portion which is arranged at an inner side of the metallic portion of the base plate, facing the cavity.

4. The piston according to claim 1, wherein the piston wall comprises a metallic portion.

5. The piston according to claim 4, wherein the plastic portion of the piston wall extends to the second end of the piston and is configured to engage with the brake pad, in particular with a back plate of the brake pad, wherein the metallic portion of the piston wall is configured not to contact the brake pad.

6. The piston according to claim 4, wherein the metallic portion of the piston wall extends to the second end of the piston and is configured to engage with the brake pad, in particular with a back plate of the brake pad.

7. The piston according to claim 4, wherein the metallic portion of the piston wall contacts the metallic portion of the piston base.

8. The piston according to claim 7, wherein the metallic portion of the piston wall is formed integrally with the metallic portion of the piston base or wherein a geometric connection feature is provided between the metallic portion of the piston wall and the metallic portion of the piston base, in particular a protrusion-recess-connection.

9. The piston according to claim 4, wherein the piston wall comprises one or more plastic portions and one or more metallic portions, forming shells arranged in layers, in particular the plastic portions and the metallic portions being arranged in alternating fashion.

10. The piston according to claim 9, wherein each layer has a thickness of 1 mm to 4 mm.

11. The piston according to claim 4, wherein a geometric feature is provided between the metallic portion of the piston wall and the plastic portion of the piston wall, in particular a step or a protrusion-recess-connection.

12. The piston according to claim 4, wherein the metallic portion of the piston wall is made of a different metal than the metallic portion of the piston base or has a different thermal expansion coefficient.

13. The piston according to claim 1, wherein the metallic portion of the piston base or the metallic portion of the piston wall comprises a sheet metal or a cast metal.

14. The piston according to claim 4, wherein the metallic portion of the piston base or the metallic portion of the piston wall comprises at least one of copper, aluminium or steel.

15. The piston according to claim 1, wherein the plastic portion of the piston base or the plastic portion of the piston wall is made of a thermoplastic.

16. The piston according to claim 1, wherein a thickness of the metallic portion of the piston base at room temperature is 3 mm to 5 mm or wherein a total thickness of the piston base is 4 mm to 8 mm.

17. A hydraulic brake system for a vehicle, comprising:
a housing,
a brake pad and
the piston according to claim 1,
wherein the piston is movable along a longitudinal axis by hydraulic pressure acting on the piston base, for pressing the second end of the piston against the brake pad.
